(19) United States
(12) Patent Application Publication
(10) Pub. No.: US 2012/0120637 A1
(43) Pub. Date: May 17, 2012

(54) CHRISTMAS TREE SCENE SYSTEMS

(76) Inventor: Crysandra Chatman, Lakeland, FL (US)

(21) Appl. No.: 13/276,657

(22) Filed: Oct. 19, 2011

Related U.S. Application Data
(60) Provisional application No. 61/412,461, filed on Nov. 11, 2010.

(51) Int. Cl. F21V 33/00; F21V 21/00; B23P 11/00; F21V 9/00

(52) U.S. Cl. 362/123; 362/230; 362/249.01; 362/249.02; 29/428

(57) ABSTRACT

Christmas tree scene system(s) comprises a unique and useful holiday decoration that adds elegance and individuality to holiday decor. The Christmas tree scene systems(s) is for adorning nursing homes, fireplace mantles, offices, and dining room tables. It is especially designed for those places with limited space. The Christmas tree scene systems, comprises: a holiday decorating assembly including, a mounting surface with at least one receiving aperture, at least one mounting dowel; a plurality of figurines (ceramic or other); electrical wiring; and LED illuminators. Further, the holiday decorating system is useful to illuminate a portion of a room and the holiday decorating assembly to create at least one holiday ambiance.

### CROSS-REFERENCE TO RELATED APPLICATION

The present application is related to and claims priority from prior provisional application Ser. No. 61/412,461, filed Nov. 11, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of holiday decoration and more specifically relates to a Christmas tree scene system.

2. Description of the Related Art

Individuals in modern society often observe holidays and/or special events. Individuals typically enjoy decorating for the holidays, but many are limited by space. It can be difficult to set up an elaborate holiday display when living in a small area, such as an apartment or dorm room. Also, many times a holiday display means, such as a large Christmas tree, consumes a large quantity of energy which may not be cost-effective for those on limited budgets.

Certain individuals may use candles for decoration; however the chance for fire is greatly increased, potentially causing harm to themselves, others and property. Others may use fruit bowls; however these may spoil over time and typically don't emit any form of light so they may not be easily seen after dark. It is desirable that a small display of holiday cheer be readily seen via illumination and be safe in use.

Various attempts have been made to solve the above-mentioned problems such as those found in U.S. Pat. Nos. 4,641,445; 2,956,357; 7,311,580; 5,911,633; 5,666,750; and 3,065,847. This prior art is representative of useful decorative holiday ornamentation. None of the above inventions and patents, taken either singly or in combination, is seen to describe the invention as claimed.

Ideally, christmas tree scene systems should be conveniently decorative and, yet operate reliably and be manufactured at a modest expense. Thus, a need exists for a reliable Christmas tree scene system that adds elegance and individuality to holiday decor and to avoid the above-mentioned problems.

### BRIEF SUMMARY OF THE INVENTION

In view of the foregoing disadvantages inherent in the known holiday decoration art, the present invention provides novel Christmas tree scene systems. The general purpose of the present invention, which will be described subsequently in greater detail is to provide a Christmas tree scene system that adds elegance and individuality to holiday decor.

The Christmas tree scene system(s) comprises a unique and useful holiday decoration that adds elegance and individuality to holiday decor. The decoration features lights that appear to dance over a holiday scene while creating useful illumination. The Christmas tree scene systems(s) is ideal for adorning nursing homes, fireplace mantles, offices, and dining room tables. The Christmas tree scene systems(s) is especially ideal for those places with limited space. The Christmas tree scene systems(s) can also be handed down through generations as a treasured keepsake.

The present invention, Christmas tree scene systems, as disclosed herein, preferably comprises: a holiday decorating assembly including, a mounting surface with at least one receiving aperture, at least one mounting dowel; a plurality of figurines (ceramic or other); electrical wiring; and at least one illuminator (illuminator is preferably an LED because of their inherent low operating temperature, and relative efficiency.) Further, the holiday decorating system is useful to illuminate a portion of a room and the holiday decorating assembly to create at least one holiday ambiance. The mounting surface provides at least one receiving aperture for receiving mounting dowels. The mounting dowels are preferably received in bottom-holes of the figurines. The plurality of figurines may be removably secured to the mounting surface via mounting dowels.

The holiday decorating assembly is able to be planar-rested on a horizontal surface to serve as a night light in preferred embodiments, or the holiday decorating assembly is able to be mounted on a vertical surface in alternate embodiments. The holiday decorating assembly may be substantially self-contained within a canopy. The canopy comprises translucent string such as fishing line or the like such as to allow the passage of light therethrough. The canopy preferably comprises an inverted conical profile such that the profile is likened to a Christmas tree shape. Alternately the holiday decorating system may comprise a holiday decorating assembly comprising an Easter theme, a Thanksgiving theme or other.

Holiday decorating assembly may be illuminated using at least one AC or DC source. Illuminator lights are powered via said electrical wiring that is in electrical communication with the power source. The illuminator lights of the holiday decorating assembly act such that illumination is given the effect of shimmering off a semi-encapsulated scene, to give a unique effect somewhat similar to snow globes. Further, the illuminator preferably comprises at least one LED as previously mentioned. LED comprises a semiconductor light source. In certain embodiments LED comprises a wavelength of about 500<λ<570 to provide green illumination. In other embodiments LED comprises a wavelength of about 610<λ<760 to provide red illumination. In other alternate embodiments LED comprises a broad spectrum wavelength to provide white illumination. LED comprises a wavelength of about 450<λ<500 to provide blue illumination. The present invention may employ any combination of the above or other LED colors, as desired.

Additionally, the holiday decorating system kit for a Christmas tree scene is described herein preferably comprising: ¾″ plywood having dimensions of ¾″ wide by 16″ by 18″; 20″ tall mounting dowels; small upholstery tacks; green, red, and blue thumb tacks; eight pounds of monofilament; garland; 1″ wood screws; wood glue; felt material; 1¼ wood balls; spray paint; hot glue; spray adhesive; white pillow filler; miniature holiday lights; assorted miniature figurines; and a set of user instructions. Figurines may comprise angels, trees, sleds, street lights, and houses and the like, according to user-preference.

A method of manufacturing a holiday decorating system is also disclosed herein preferably comprising the steps of: cutting a base; cutting a felt cover to cover the base; counter-sinking a hole into the base; attaching a distal end of a dowel to the base; gluing the felt cover to the base; installing fasteners to a perimeter of the base; painting the perimeter of the base, ball-knobs, and caps; placing a first screw into a proximate end of the mounting dowel and a second screw into a center-bottom of the base; attaching a light string with lights to the base and winding the light string upwardly and circumferentially around the mounting dowel; arranging and gluing a first garland about the dowel such that the lights are visible; affixing at least one miniature figurine to the base; attaching cotton to the base around the miniature figurines and the lights such that the lights are visible; connecting at least one translucent string to the fasteners on the base and to the first screw on the proximate end of the mounting dowel; attaching the ball-knob to the proximate end of the mounting dowel; and attaching a second garland around the base circumferentially.

The present invention holds significant improvements and serves as Christmas tree scene systems. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Christmas tree scene systems, constructed and operative according to the teachings of the present invention.

FIG. 1 shows a perspective view illustrating a holiday decorating system of Christmas tree scene systems according to an embodiment of the present invention.

FIG. 2 shows a perspective view illustrating another embodiment of the holiday decorating system of the Christmas tree scene systems according to an embodiment of the present invention.

FIG. 3 shows another perspective view illustrating yet another embodiment of the holiday decorating system of the Christmas tree scene systems according to an embodiment of the present invention.

FIG. 4 shows another perspective view illustrating yet another embodiment of the holiday decorating system of the Christmas tree scene systems according to an embodiment of the present invention.

FIG. 5 shows another perspective view illustrating yet another embodiment of holiday decorating system of the Christmas tree scene systems according to an embodiment of the present invention.

FIG. 6 is a flowchart illustrating a method of use for the holiday decorating system of the Christmas tree scene systems according to an embodiment of the present invention of FIGS. 1-5.

The various embodiments of the present invention will hereinafter be described in conjunction with the appended drawings, wherein like designations denote like elements.

### DETAILED DESCRIPTION

As discussed above, embodiments of the present invention relate to a holiday decoration and more specifically relates to a Christmas tree scene system 100 that adds elegance and individuality to holiday decor. Christmas tree scene systems(s) 100 is preferably ideal for adorning nursing homes, fireplace mantles, offices, and dining room tables. Christmas tree scene system 100 is especially ideal for those places with limited space. Christmas tree scene systems(s) 100 can also be handed down through generations as a treasured keepsake.

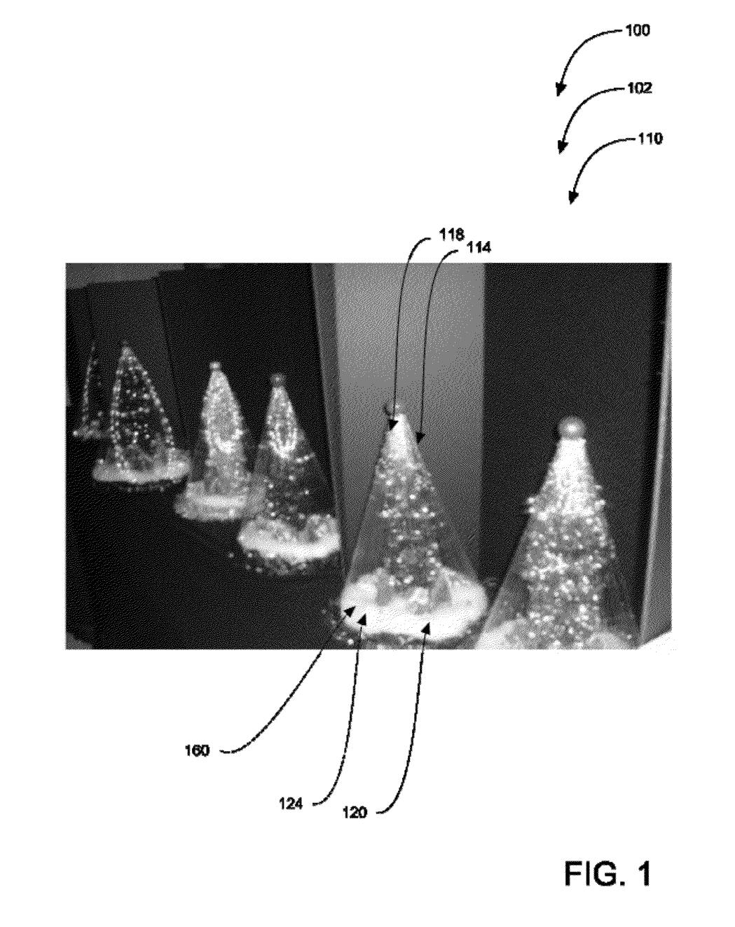

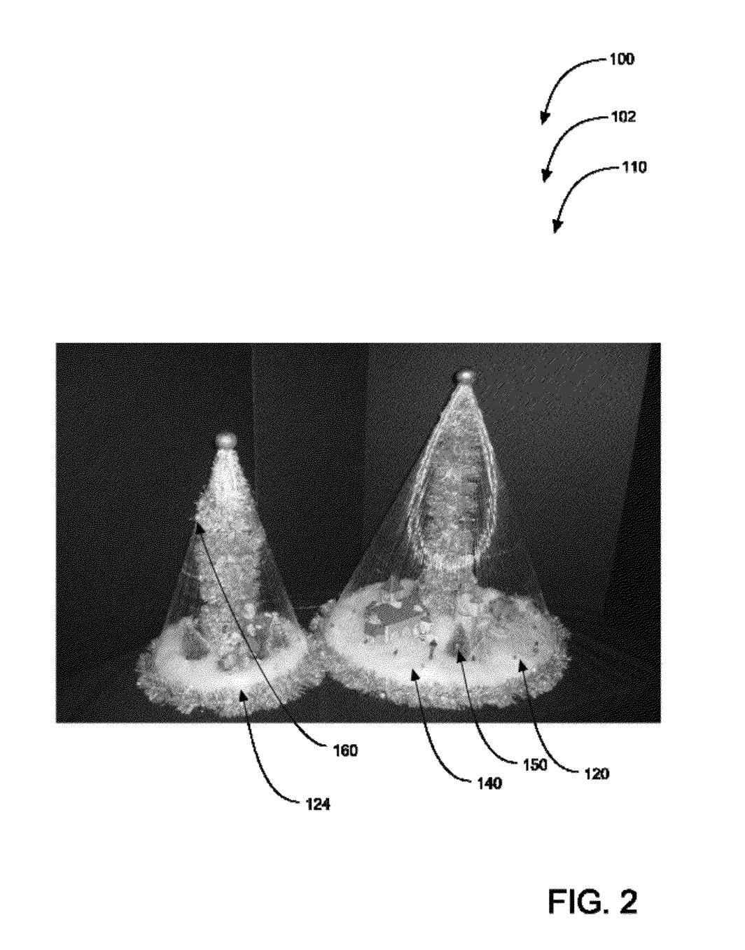

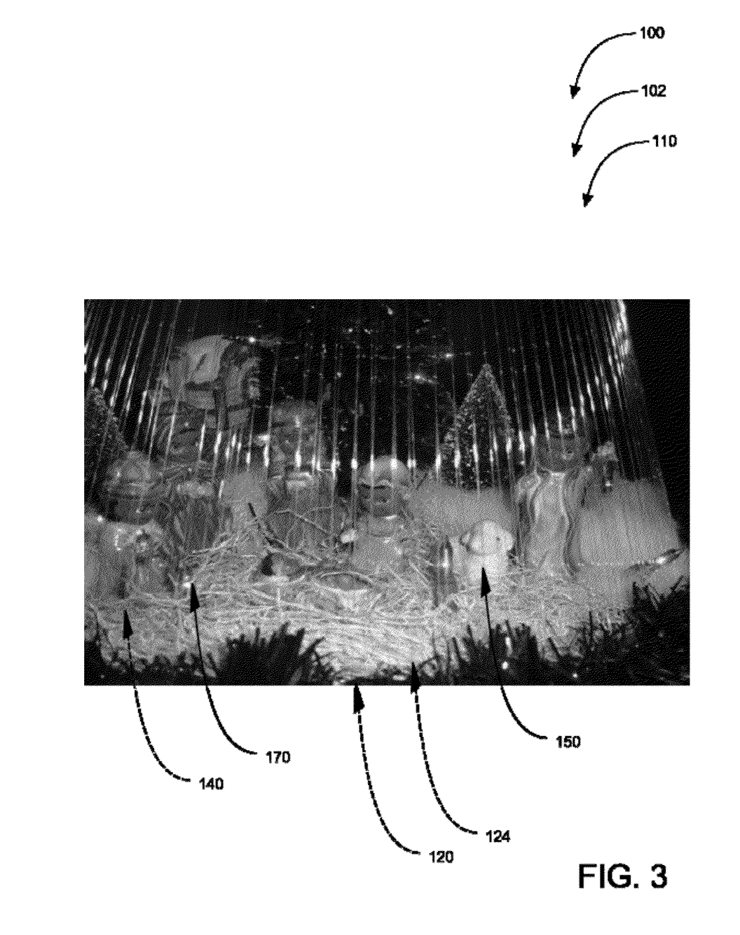

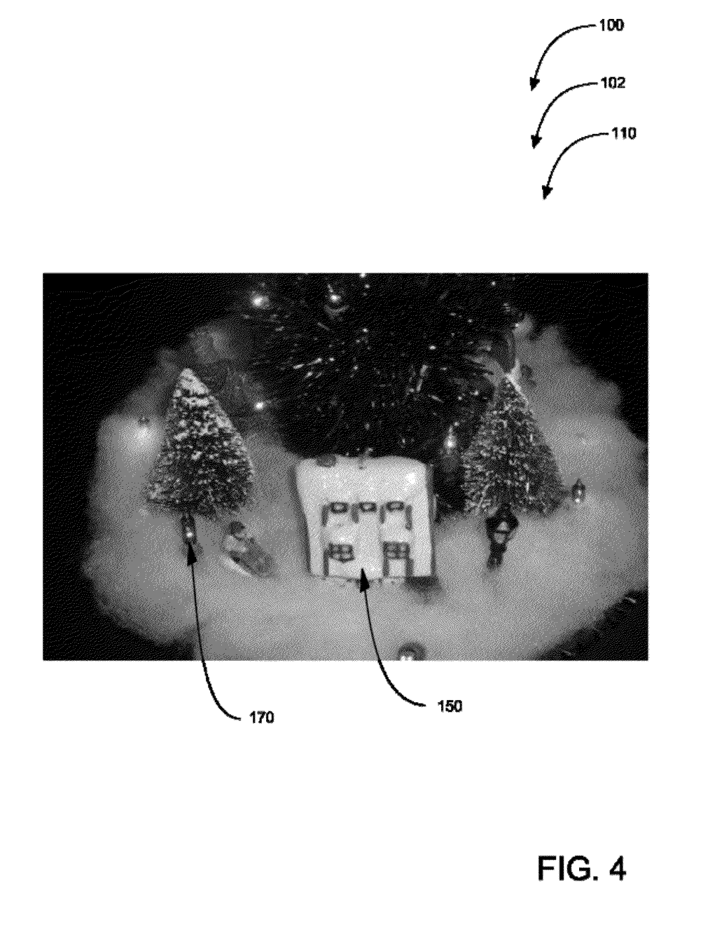

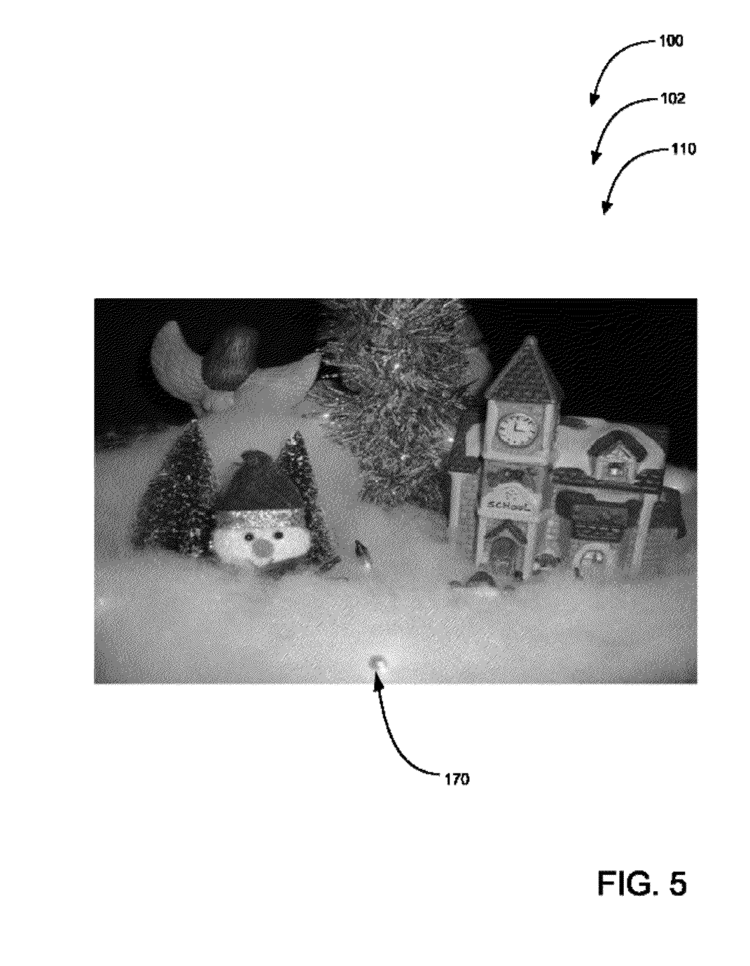

Referring now to the drawings FIGS. 1-5, showing perspective views of holiday decorating system 102 of the Christmas tree scene systems 100 according to embodiments of the present invention.

Holiday decorating system 102 herein preferably comprises: holiday decorating assembly 110 including, mounting surface 120 with at least one receiving aperture, 124 at least one mounting dowel 140; plurality of figurines 150 (ceramic or other); electrical wiring 160; and at least one illuminator 170 (illuminator is preferably an LED because of their inherent low operating temperature, and relative efficiency.) Further, holiday decorating system 102 is useful to illuminate a portion of a room and holiday decorating assembly 110 to create at least one holiday ambiance and allowing individuals to move about freely in the dimly lit space, that might normally be dark. Mounting surface 120 preferably provides at least one receiving aperture 120 for receiving mounting dowels 140. Mounting dowels 140 are preferably received in bottom-holes of figurines 150. Figurines 150 are preferably removably secured to mounting surface 120 via mounting dowels 140.

Holiday decorating assembly 110 is preferably able to be planar-rested on a horizontal surface such as a table, countertop, or shelf and may also serve as a night light. Further, holiday decorating assembly 110 is preferably able to be mounted on a vertical surface such as a wall for example or hung from a tree or fastener. Holiday decorating assembly 110 is preferably substantially self-contained within canopy 114. Canopy 114 preferably comprises translucent string such as fishing line or the like. Additionally, canopy 114 preferably comprises inverted conical profile 118 such that inverted conical profile 118 is likened to a Christmas tree in shape (and ambience.) Alternately holiday decorating system 102 may comprise holiday decorating assembly 110 comprising an Easter theme, or Thanksgiving theme. Upon reading this specification, it should be appreciated that, under appropriate circumstances, considering such issues as user preferences, design preference, structural requirements, marketing preferences, cost, available materials, technological advances, etc., other holiday themes such as, for example, Halloween, Hanukah, etc., may be used an/or designed as per user-demand. Further, the device may comprise various shapes and profiles including spherical, semi-spherical, cube, rectangular, oval or the like.

Holiday decorating assembly 110 is preferably illuminated using at least one AC or DC source. Illuminator 170 comprises lights which are connected to power source via electrical wiring 160 such that illumination via illuminator 170 preferably gives the effect of shimmering off a semi-encapsulated scene when activated. Illuminator 170 preferably comprises at least one LED as previously mentioned. LED comprises a semiconductor light source in preferred embodiments. In certain embodiments LED comprises a wavelength of about 500<λ<570 to provide green illumination. In other embodiments LED comprises a wavelength of about 610<λ<760 to provide red illumination. In other alternate embodiments LED comprises a broad spectrum wavelength to provide white illumination. LED comprises a wavelength of about 450<λ<500 to provide blue illumination. The present invention may employ any combination of the above or other LED colors, as desired.

Christmas tree scene systems 100 according to an embodiment of the present invention of FIGS. 1-4 may comprise kit 440. Kit 440 may comprise the following parts: ¾″ plywood having dimensions of ¾″ wide by 16″ by 18″; 20″ tall mounting dowels 140; small upholstery tacks; green, red, and blue thumb tacks; eight pounds of monofilament; garland; 1″ wood screws; wood glue; felt material; 1¼ wood balls; spray paint; hot glue; spray adhesive; white pillow filler; miniature holiday lights; assorted miniature figurines 150; and a set of user instructions (or may come pre-assembled or non-assembled.) Figurines 150 may comprise angels, trees, sleds, street lights, and houses and other decorative objects. Additionally, kit 440 may be sold as individual components depending on wholesaler/retailer-preference. Additionally, the present invention may be for use as a craft project using the directions provided herein.

Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately. Further, all dimensions listed are approximate lengths, widths, and heights and may be altered and still be within the scope of the present invention.

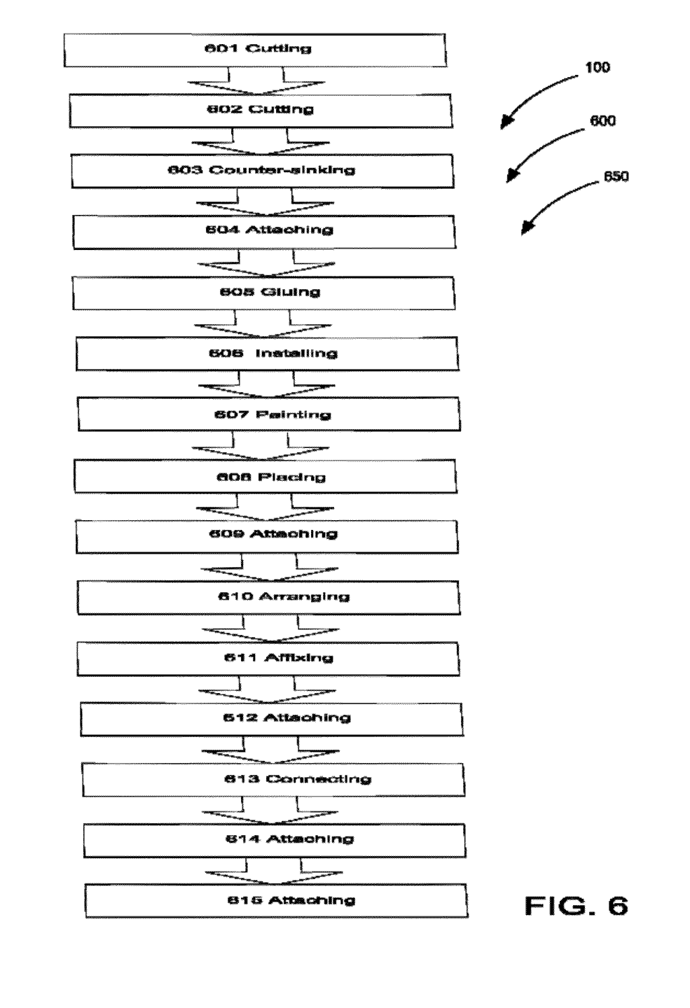

FIG. 6. shows flowchart 650 illustrating method of use 600 according to an embodiment of the present invention of FIGS. 1-5.

A method of using (at least herein enabling method of use 600) Christmas tree scene systems 100 may comprise the steps of: step one 601 cutting a base; step two 602 cutting a felt cover to cover the base; step three 603 counter-sinking a hole into the base; step four 604 attaching a distal end of mounting dowel 140 to the base; step five 605 gluing the felt cover to the base; step six 606 installing fasteners to a perimeter of the base; step seven 607 painting the perimeter of the base, ball-knobs, and caps; step eight 608 placing a first screw into a proximate end of mounting dowel 140 and a second screw into a center-bottom of the base; step nine 609 attaching a light string with lights to the base and winding the light string upwardly and circumferentially around mounting dowel 140; step ten 610 arranging and gluing a first garland about mounting dowel 140 such that the lights are visible; step eleven 611 affixing at least one miniature figurine 150 to the base; step twelve 612 attaching cotton to the base around miniature figurines 150 and the lights such that the lights are visible; step thirteen 613 connecting at least one translucent string to the fasteners on the base and to the first screw on the proximate end of mounting dowel 140; step fourteen 614 attaching the ball-knob to the proximate end of mounting dowel 140; and step fifteen 615 attaching a second garland around the base circumferentially.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A holiday decorating system comprising:
a holiday decorating assembly including,
a mounting surface with at least one receiving aperture,
at least one mounting dowel;
a plurality of figurines;
electrical wiring; and
at least one illuminator;
wherein said mounting surface provides at least one receiving aperture for receiving mounting dowels;
wherein said plurality of figurines are removably secured to said mounting surface via said mounting dowels;
wherein said mounting dowels are received in bottom-holes of said figurines;
wherein said illuminator lights are powered via said electrical wiring;
wherein said illuminator lights said holiday decorating assembly such that illumination is given the effect of shimmering off a semi-encapsulated scene; and
wherein said holiday decorating system is useful to illuminate a portion of a room and said holiday decorating assembly usable to create at least one holiday ambiance.

2. The holiday decorating system of claim 1 wherein said holiday decorating assembly is substantially self-contained within a canopy.

3. The holiday decorating system of claim 1 wherein said holiday decorating assembly comprises an Easter theme.

4. The holiday decorating system of claim 1 wherein said holiday decorating assembly comprises a Thanksgiving theme.

5. The holiday decorating system of claim 1 wherein said holiday decorating assembly is illuminated using at least one AC source.

6. The holiday decorating system of claim 1 wherein said holiday decorating assembly is able to be planar-rested on a horizontal surface to serve as a night light.

7. The holiday decorating system of claim 1 wherein said holiday decorating assembly is able to be mounted on a vertical surface.

8. The holiday decorating system of claim 1 wherein said illuminator comprises at least one LED.

9. The holiday decorating system of claim 8 wherein said LED comprises a semiconductor light source.

10. The holiday decorating system of claim 9 wherein said LED comprises a wavelength of about 500<λ<570.

11. The holiday decorating system of claim 9 wherein said LED comprises a wavelength of about 610<λ<760.

12. The holiday decorating system of claim 9 wherein said LED comprises a broad spectrum wavelength.

13. The holiday decorating system of claim 9 wherein said LED comprises a wavelength of about 450<λ<500.

14. The holiday decorating system of claim 2 wherein said canopy comprises translucent string.

15. The holiday decorating system of claim 14 wherein said canopy comprises an inverted conical profile.

16. A holiday decorating system kit for a Christmas tree scene comprising:
¾″ plywood having dimensions of about ¾″ wide by 16″ by 18″;
20″ tall wood dowels;
upholstery tacks;
green, red, and blue thumb tacks;
eight pounds of monofilament;
garland;
1″ wood screws;
wood glue;
felt material;
1¼ wood balls;
spray paint;
hot glue;
spray adhesive;
white pillow filler;
miniature holiday lights;
assorted miniature figurines; and
a set of user instructions.

17. The holiday decorating system kit for a Christmas tree scene of claim 16 wherein said figurines comprise angels, trees, sleds, street lights, and houses.

18. A method of manufacturing a holiday decorating system comprising the steps of:
cutting a base;
cutting a felt cover to cover said base;
counter-sinking a hole into said base;
attaching a distal end of a dowel to said base;
gluing said felt cover to said base;
installing fasteners to a perimeter of said base;
painting said perimeter of said base, ball-knobs, and caps;
placing a first screw into a proximate end of said dowel and a second screw into a center-bottom of said base;
attaching a light string with lights to said base and winding said light string upwardly and circumferentially around said dowel;
arranging and gluing a first garland about said dowel such that said lights are visible;
affixing at least one miniature figurine to said base;
attaching cotton to said base around said miniature figurines and said lights such that said lights are visible;
connecting at least one translucent string to said fasteners on said base and to said first screw on said proximate end of said dowel;
attaching said ball-knob to said proximate end of said dowel; and
attaching a second garland around said base circumferentially.
